(19) United States
(12) Patent Application Publication
(10) Pub. No.: US 2014/0293482 A1
(43) Pub. Date: Oct. 2, 2014

(54) ROTATING DEVICE

(71) Applicant: Samsung Electro-Mechanics Japan Advanced Technology Co., Ltd., Shizuoka (JP)

(72) Inventors: Mitsuo KODAMA, Shizuoka (JP); Taketo Nonaka, Shizuoka (JP); Hiroshi Kato, Shizuoka (JP)

(73) Assignee: Samsung Electro-Mechanics Japan Advanced Technology Co., Ltd., Shizuoka (JP)

(21) Appl. No.: 14/224,865

(22) Filed: Mar. 25, 2014

(30) Foreign Application Priority Data
Mar. 26, 2013 (JP) 2013-063398
Mar. 26, 2013 (JP) 2013-063399

(51) Int. Cl. G11B 19/20

(52) U.S. Cl. CPC G11B 19/2036
USPC 360/99.08

(57) ABSTRACT

A rotating device includes a rotor on which a magnetic recording disk is to be mounted and a stator configured to rotatably support the rotor. The stator includes a support projection extending along a rotating axis of the rotor, a shaft configured to surround the support projection and fixed to the support projection, a top cover covering the rotor, and a shaft fixing screw configured to fix the top cover to the shaft. The shaft fixing screw enters a shaft fixing screw hole formed in the support projection along the rotating axis.

### REFERENCE TO RELATED APPLICATION

The present application claims benefit to Japanese Patent Application Nos. 2013-063398 and 2013-0633991, both filed on Mar. 26, 2013, whose disclosures are hereby incorporated by reference in their entirety into the present disclosure.

### BACKGROUND OF THE INVENTION

1. Field of the Invention

The present invention relates to a rotating device configured to rotate a magnetic recording disk.

2. Description of the Related Art

Recently, disk drive devices such as hard disk drives are available in smaller sizes and with larger capacity and are installed in a variety of electronic devices. In particular, more and more disk drive devices are installed in mobile electronic devices such as notebook personal computers and mobile music players.

In the related arts, motors in which a fluid dynamic bearing mechanism is employed in the bearing are proposed.

### SUMMARY OF THE INVENTION

One embodiment of the present invention relates to a rotating device. The rotating device includes: a rotor on which a magnetic recording disk is to be mounted; and a stator configured to rotatably support the rotor via a fluid dynamic bearing. The stator includes: an inner part extending along a rotating axis of the rotor; an outer part surrounding the inner part and fixed to the inner part; a cover configured to cover the rotor; and a joint configured to fix the cover to the outer part. The joint enters a hole formed in the inner part along the rotating axis.

Another embodiment also relates to a rotating device. The rotating device includes: a rotor on which a magnetic recording disk is to be mounted; and a stator configured to rotatably support the rotor via a fluid dynamic bearing. The stator includes: an inner part extending along a rotating axis of the rotor; an outer part surrounding the inner part and fixed to the inner part; a cover configured to cover the rotor; and a joint configured to fix the cover to the outer part. The joint enters an admission hole formed in the inner part along the rotating axis. A lubricant hole accommodating a lubricant for the fluid dynamic bearing is formed in one of the rotor and the stator. A surface of the other of the rotor and the stator facing an edge of the lubricant hole has a shape adapted to the edge of the lubricant hole.

Still another embodiment also relates to a rotating device. The rotating device includes: a rotor on which a magnetic recording disk is mounted; and a stator configured to rotatably support the rotor via a fluid dynamic bearing. A lubricant hole accommodating a lubricant for the fluid dynamic bearing is formed in one of the rotor and the stator. A surface of the other of the rotor and the stator facing an edge of the lubricant hole has a shape adapted to the edge of the lubricant hole.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A, 1B and 1C show the rotating device according to the embodiment;

FIG. 2 shows a A-A cross section of FIG. 1A;

FIGS. 3A and 3B are schematic diagrams illustrating the relative positions of the edge facing recess and the edge at the upper end of the bypass communication hole;

FIG. 4 is an enlarged view of a part of FIG. 2;

FIG. 5 shows a cross section of the shaft of the rotating device according to the first variation and the neighborhood thereof;

FIG. 6 is an enlarged view of a part of FIG. 5 bounded by a broken line;

FIG. 7 shows a partial cross section of a main part of the rotating device according to the second variation; and

FIG. 8 shows a cross section of the shaft of the rotating device according to the third variation and the neighborhood thereof.

### DETAILED DESCRIPTION OF THE INVENTION

The invention will now be described by reference to the preferred embodiments. This does not intend to limit the scope of the present invention but to exemplify the invention. The size of the component in each figure may be changed in order to aid understanding. Some of the components in each figure may be omitted if they are not important for explanation.

The rotating device according to the embodiment is suitably used as a disk drive device such as a hard disk drive configured to mount a magnetic recording disk, and to rotationally drive the magnetic recording disk thus mounted. In particular, such a rotating device according to the embodiment is suitably used as a fixed shaft disk drive device in which a shaft is fixed to a base and a hub is rotated with respect to the shaft.

First, a summary of the rotating device according to the embodiment will be given. Recently, the thickness of mobile electronic devices has been reduced quite dramatically. Associated with this, rotating devices such as disk drive devices are required to be even thinner. As the thickness of a rotating device is reduced, the base plate should necessarily be thin. In fixed shaft disk drive devices, the shaft may be inserted into a hole provided in the base plate and fixed therein. In this case, the strength of bond between the shaft and the base plate may be lowered as the base plate becomes thin. Such a situation could occur not only in disk drive devices but also in rotating devices of other types. The rotating device according to the embodiment includes a rotor on which a magnetic recording disk is to be mounted and a stator configured to rotatably support the rotor. The stator includes an inner part extending along the rotating axis of the rotor, an outer part surrounding the inner part and fixed to the inner part, a cover configured to cover the rotor, and a joint configured to fix the cover to the outer part. The joint enters a hole formed in the inner part along the rotating axis. This maintains or improves the strength of bond between members in the rotating device according to the embodiment even if the thickness of the device is reduced.

In rotating devices like disk drive devices, a communication hole bypassing a dynamic pressure generation part may be formed in the rotor or the stator in order to average the dynamic pressure generated in the lubricant as the rotor is rotated. The communication hole is formed by drilling or laser processing. Due to the nature of the process of forming a hole, the edge burr may remain on the edge of the hole thus formed. When the edge burr is removed due to, for example, physical contact and enters the lubricant, the operation of the disk drive device may be adversely affected. Such a situation could occur not only in disk drive devices but also in rotating devices of other types. The rotating device according to the embodiment includes a rotor on which a magnetic recording disk is to be mounted and a stator configured to rotatably support the rotor via a fluid dynamic bearing. A lubricant hole accommodating a lubricant for the fluid dynamic bearing is formed in one of the rotor and the stator. The surface of the other of the rotor or the stator facing the edge of the lubricant hole has a shape adapted to the edge of the lubricant hole. This can reduce or eliminate adverse effects of the edge burr on the operation of the rotating device even if the edge burr remains on the edge of the hole in which the lubricant enters. A detailed description will now be given of the rotating device according to the embodiment.

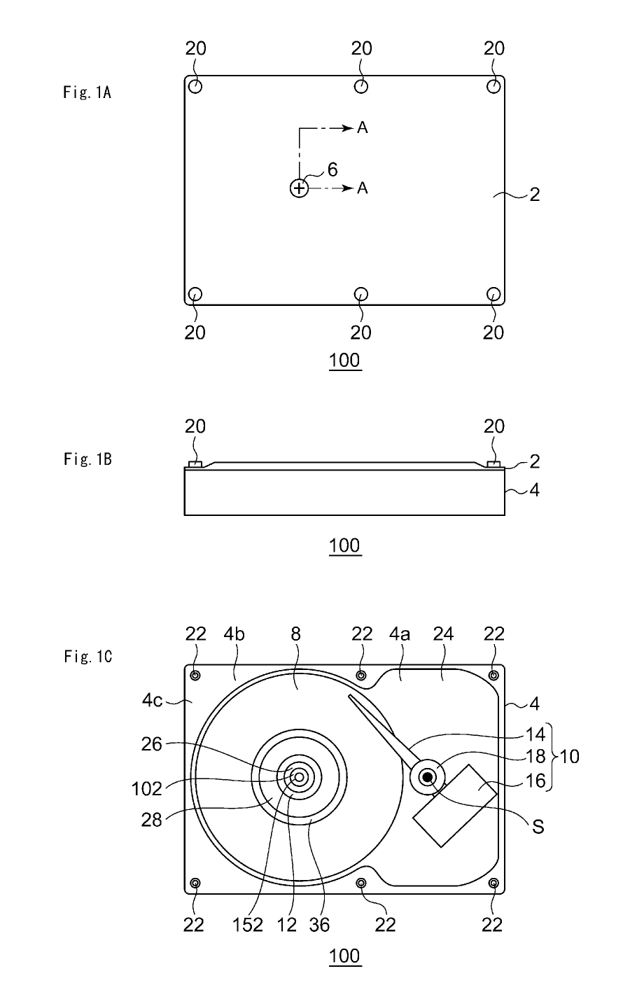

FIGS. 1A, 1B and 1C show the rotating device 100 according to the embodiment. FIG. 1A is a top view of the rotating device 100. FIG. 1B is a side view of the rotating device 100. FIG. 1C is a top view of the rotating device 100 with a top cover 2 removed. The rotating device 100 includes a stator, a rotor driven into rotation with respect to the stator, a magnetic recording disk 8 mounted on the rotor, and a data read/write unit 10. The stator includes a base 4, a shaft 26 fixed to the base 4, a housing 102 supporting the shaft 26, a top cover 2, six screws 20, and a shaft fixing screw 6. The rotor includes a hub 28, a clamper 36, and a cover ring 12. Hereinafter, it is assumed that the side of the base 4 on which the hub 28 is installed is the “upper” side.

The magnetic recording disk 8 is a 2.5-inch disk made of glass and having a diameter of 65 mm. The diameter of the hole at the center is 20 mm and the thickness of the disk is 0.65 mm. One magnetic recording disk 8 can be mounted on the hub 28.

The base 4 is formed by die-casting an aluminum alloy. The base 4 includes a bottom plate 4a defining the bottom of the rotating device 100 and an outer circumferential wall 4b formed along the outer circumference of the bottom plate 4a so as to surround the area where the magnetic recording disk 8 is mounted. An upper surface 4c of the outer circumferential wall 4b is provided with six screw holes 22. The base 4 may be formed by pressing a steel plate, an aluminum plate, or the like.

The surface of the base 4 is coated in order to prevent exfoliation of the surface of the base 4. The surface may be coated with a resin material such as epoxy resin. Alternatively, the surface may be coated by plating the surface with a metal such as nickel and chromium. According to the embodiment the surface of the base 4 is electroless nickel plating. As compared with the coating with a resin material, nickel plating increases the hardness of the surface and lowers the friction coefficient. Nickel plating also lowers the likelihood that the surface of the base 4 or the magnetic recording disk 8 is damaged when the magnetic recording disk 8 is brought into contact with the surface of the base 4. According to the embodiment, the static friction coefficient on the surface of the base 4 is between 0.1 and 0.6. As compared with cases where the static friction coefficient is 2 or higher, the likelihood of damaged of the base 4 or the magnetic recording disk 8 is lowered even more successfully.

The data read/write unit 10 includes a read/write head (not shown), a swing arm 14, a voice coil motor 16, and a pivot assembly 18. The read/write head is attached to the end of the swing arm 14 and is configured to write data in the magnetic recording disk 8 and read data from the magnetic recording disk 8. The pivot assembly 18 pivotally supports the swing arm 14 around a head rotating axis S with respect to the base 4. The voice coil motor 16 pivotally moves the swing arm 14 around the head rotating axis S so as to move the read/write head to a desired position on the upper surface of the magnetic recording disk 8. The voice coil motor 16 and the pivot assembly 18 are formed by using a known technology for controlling the position of the head.

The top cover 2 covers the rotor. The top cover 2 is fixed on the upper surface 4c of the outer circumferential wall 4b of the base 4 using the six screws 20. The six screws 20 correspond to the six screw holes 22. It should be noted that the top cover 2 and the upper surface 4c of the outer circumferential wall 4b are secured to each other so that leak to a space inside the rotating device 100 does not occur at the joint. The space inside the rotating device 100 is defined as a clean space 24 bounded by the bottom plate 4a of the base 4, the outer circumferential wall 4b of the base 4, and the top cover 2. The clean space 24 is designed to be sealed, i.e., leak-in from outside or leak-out to outside does not occur. The clean space 24 is filled with clean air in which particles are removed. This helps prevent attachment of foreign materials such as particles on the magnetic recording disk 8 and improves the reliability of the operation of the rotating device 100.

The shaft 26 extends along the rotating axis of the hub 28. A shaft fixing screw hole 152 is provided on the upper end face of the housing 102. The shaft fixing screw 6 secure the top cover 2 with respect to the shaft 26 by being threaded into the shaft fixing screw hole 152 through the top cover 2.

Of the fixed shaft rotating devices, rotating devices of a type in which the ends of the shaft 26 are fixed to the chassis such as the base 4 and the top cover 2 withstand shock and vibration of the rotating device efficiently.

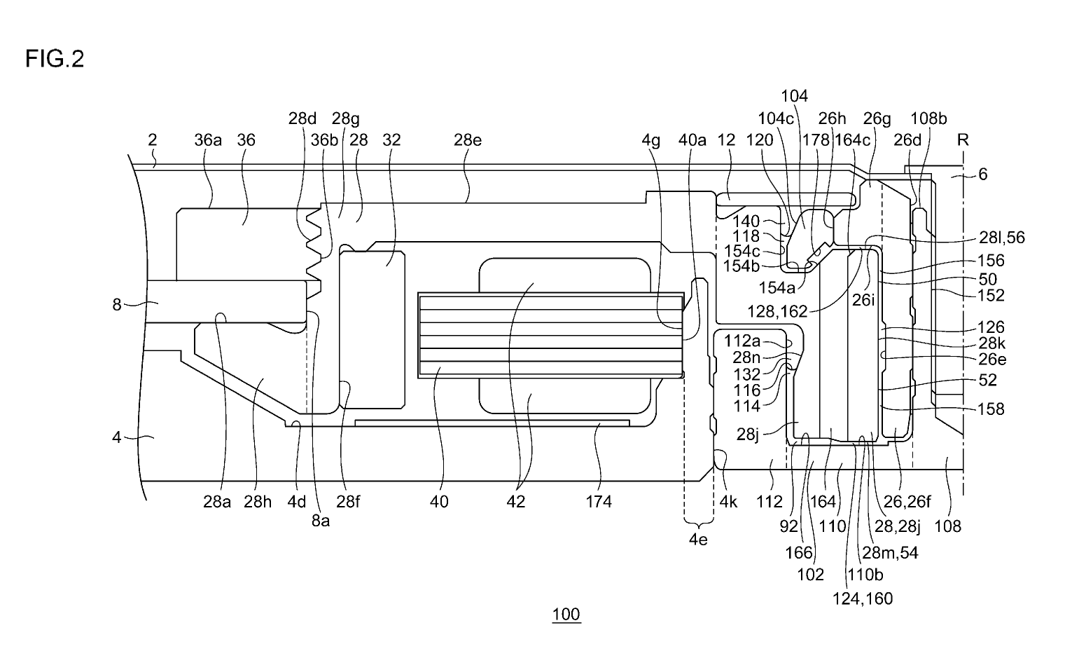

FIG. 2 shows a A-A cross section of FIG. 1A. FIG. 2 shows a halved cross section of the motor part of the rotating device 100. The rotor includes a hub 28, a clamper 36, a cylindrical magnet 32, and a cover ring 12. The stator includes a base 4, a laminated core 40, a coil 42, a housing 102, a shaft 26, and a ring part 104. A lubricant 92 is interposed continuously in a part of the gap between the rotor and the stator.

The hub 28 is formed by cutting or pressing a soft magnetic steel member such as SUS430 and molded into a predetermined cup-like shape. The surface of the hub 28 may be subject to a surface layer formation process such as electroless nickel plating in order to prevent exfoliation of the surface of the hub 28. The hub 28 includes a shaft surrounding part 28j surrounding the shaft 26, a hub projection 28g provided radially outside the shaft surrounding part 28j and fitted into a central hole 8a of the magnetic recording disk 8, and a mounting unit 28h provided radially outside the hub projection 28g. The magnetic recording disk 8 is mounted on a disk mounting surface 28a, i.e., the upper surface of the mounting unit 28h. The magnetic recording disk 8 is fixed with respect to the hub 28 by being sandwiched by the clamper 36 and the mounting unit 28h.

The clamper 36 exerts a downward force on the upper surface of the magnetic recording disk 8 so as to press the magnetic recording disk 8 onto the disk mounting surface 28a. The clamper 36 is engaged with an outer peripheral surface 28d of the hub projection 28g. The clamper 36 and the outer peripheral surface 28d of the hub projection 28g may be coupled by a mechanical joint means such as threading, integration, or press-fitting, or by a magnetic means, utilizing magnetic attraction.

The clamper 36 is formed such that an upper surface 36a of the clamper 36 does not project above an upper surface 28e of the hub projection 28g when the clamper 36 is exerting a desired downward force to the magnetic recording disk 8.

For example, when the clamper 36 and the outer peripheral surface 28d of the hub projection 28g are threaded, a male thread is formed on the outer peripheral surface 28d of the hub projection 28g and a corresponding female thread is formed on an inner peripheral surface 36b of the clamper 36. In this case, the strength of the downward force exerted by the clamper 36 on the upper surface of the magnetic recording disk 8 can be relatively accurately controlled according to the strength of threading. The clamper 36 may be formed of a plurality of members or formed as one piece.

If a burr produced by working the hub is attached to the outer peripheral surface 28d of the hub projection 28g, the clamper 36 may be in contact with the burr and the burr may be exfoliated when the clamper 36 is threaded on the outer peripheral surface 28d. The outer peripheral surface 28d of the hub projection 28g may be subject to a burr removal process to remove the burr in advance.

The cylindrical magnet 32 is adhesively fixed to a cylindrical inner peripheral surface 28f, which represents an inner cylindrical surface of the hub 28. For example, the cylindrical magnet 32 is formed of a rare-earth magnetic material or a ferrite magnetic material. According to the embodiment, the cylindrical magnet 32 is formed of a neodymium-based rare-earth magnetic material. Twelve driving magnetic poles are provided on the cylindrical magnet 32 in the circumferential direction (direction around a rotating axis R and tangential to a circle perpendicular to the rotating axis R). The cylindrical magnet 32 faces nine salient poles of the laminated core 40 in a radial direction (i.e., the direction perpendicular to the rotating axis R).

The laminated core 40 has an annular part and nine salient poles extending therefrom radially outward and is fixed near an upper surface 4d of the base 4. The laminated core 40 is formed by laminating six magnetic steel sheets of a thickness of 0.2 mm and integrating the sheets. For example, the laminated core 40 may be formed by laminating 2-20 thin magnetic steel sheets of a thickness of 0.1 mm-0.8 mm. The surface of the laminated core 40 may be coated for insulation by electrodeposition coating or powder coating. The coil 42 is wound around the salient poles of the laminated core 40. A driving magnetic flux is generated along the salient poles by a three-phase substantially sinusoidal driving current flowing through the coil 42.

The base 4 has an annular base projection 4e around the rotating axis R of the rotor. The base projection 4e projects upward so as to surround the housing 102. The laminated core 40 is fixed to the base 4 by fitting a central hole 40a of the annular part of the laminated core 40 into an outer peripheral surface 4g of the base projection 4e. In particular, the annular part of the laminated core 40 is fitted to the base projection 4e with a press-fit or clearance fit and glued thereon. According to the embodiment, about 60-90% of the thickness of the annular part of the laminated core 40 in the axial direction is press-fitted to the outer peripheral surface 4g of the base projection 4e in order to reduce vibration of the laminated core 40.

That part of the upper surface 4d of the base 4 corresponding to the salient poles and the coil 42 is provided with an insulating sheet made of resin such as PET or a tape 174.

The housing 102 includes a flat annular housing bottom 110, a cylindrical base side surrounding portion 112 fixed to the outer circumference of the housing bottom 110, and a support projection 108 fixed to the inner circumference of the housing bottom 110 and extending along the rotating axis R. The housing 102 defines an annular support recess 166 in which the lower end of the shaft surrounding part 28j as well as the shaft 26 enter.

The base side surrounding portion 112 is surrounded by the base projection 4e. The base side surrounding portion 112 is fitted into a bearing hole 4k, which is a through hole provided in the base 4 around the rotating axis R, and is adhesively fixed to the bearing hole 4k.

The shaft 26 is formed with a support hole 26d, which is a through hole around the rotating axis R. The support projection 108 is inserted into the support hole 26d and fixed therein. In other words, the shaft 26 surrounds the support projection 108 and is fixed by the support projection 108.

An upper end face 108b of the support projection 108 is formed with a non-penetrating shaft fixing screw hole 152 that extends along the rotating axis R. The shaft fixing screw 6 enters the shaft fixing screw hole 152 and is threaded into the shaft fixing screw hole 152. Threading and adhesion may be employed in combination in order to improve bonding strength. The shaft 26, the support projection 108, and the shaft fixing screw 6 are positioned such that the support projection 108 is sandwiched by the shaft 26 and the shaft fixing screw 6 in the radial direction, or the support projection 108 is interposed between the shaft 26 and the shaft fixing screw 6. The shaft fixing screw 6 is not in contact with the shaft 26 but is indirectly fixed to the shaft 26.

The shaft 26 includes a body 26f extending along the rotating axis R and surrounding the support projection 108, and a flange 26g extending from the upper end of the body 26f in the radially outward direction.

The ring part 104 surrounds the flange 26g and is fixed to an outer peripheral surface 26h of the flange 26g. The ring part 104 is fixed to the flange 26g by press-fitting and adhesion. The adhesive agent introduced between the ring part 104 and the flange 26g also functions as a seal member for sealing a gap between the ring part 104 and the flange 26g and preventing leakage of the lubricant 92.

The shaft surrounding part 28j surrounds the body 26f. The lubricant 92 is interposed between the shaft surrounding part 28j and the body 26f. In other words, an inner peripheral surface 28k of the shaft surrounding part 28j and an outer peripheral surface 26e of the body 26f face each other via a first gap 126 and the first gap 126 is filled with the lubricant 92. The lubricant 92 includes a fluorescent material. When irradiated by light such as ultraviolet light, the lubricant 92 emits light with a wavelength different from that of the irradiating light (e.g., blue light or green light) due to the action of the fluorescent material. By including a fluorescent material in the lubricant 92, the liquid surface of the lubricant 92 can be easily inspected. The fluorescent material also makes it easy to identify attachment of the lubricant 92 or leakage of the lubricant 92.

The shaft surrounding part 28j is sandwiched by the assembly including the flange 26g and the ring part 104, and the housing 102 in the axial direction (i.e., the direction parallel to the rotating axis R). The lubricant 92 is interposed between the shaft surrounding part 28j and the ring part 104, between the shaft surrounding part 28j and the flange 26g, and between the shaft surrounding part 28j and the housing 102. In other words, a flange-facing surface 281 of the shaft surrounding part 28j and an under surface 26i of the flange 26g face each other via a second gap 128, and the second gap 128 is filled with the lubricant 92. The flange-facing surface 281 is a disk-shaped surface having a normal substantially parallel to the rotating axis R. A lower surface 28m of the shaft surrounding part 28j and an upper surface 110b of the housing bottom 110 face each other via a third gap 124, and the third gap 124 is filled with the lubricant 92.

The base side surrounding portion 112 and the shaft surrounding part 28j are positioned such that the base side surrounding portion 112 surrounds the lower part of the shaft surrounding part 28j. Between the base side surrounding portion 112 and the shaft surrounding part 28j is formed a first taper seal 114 in which a fourth gap 132 between an inner peripheral surface 112a of the base side surrounding portion 112 and an outer peripheral surface 28n of the lower part of the shaft surrounding part 28j gradually increases in the upward direction. The first taper seal 114 has a first gas-liquid interface 116 of the lubricant 92 and prevents leakage of the lubricant 92 by a capillary action.

The upper surface of the shaft surrounding part 28j is formed with an annular sleeve recess around the rotating axis R. The sleeve recess is concave downward. The sleeve recess has a first recess surface 154a extending obliquely downward in the radial direction from the outer edge of the flange-facing surface 281, a second recess surface 154b extending substantially parallel to the radial direction from the outer edge of the first recess surface 154a, and a third recess surface 154c axially extending upward from the outer edge of the second recess surface 154b. The normal of the first recess surface 154a is parallel to a direction intersecting the axial direction. It should be noted that the angle formed by the normal to the first recess surface 154a and the rotating axis R may be within a range of 30° and 60°. The ring part 104 enters the sleeve recess.

A ninth gap 140 between the third recess surface 154c and an outer peripheral surface 104c of the ring part 104 defines a second taper seal 118 which gradually increases in the upward direction. The second taper seal 118 has a second gas-liquid interface 120 of the lubricant 92 and prevents leakage of the lubricant 92 by a capillary action.

The first gap 126 includes two radial dynamic pressure generation parts 156 and 158 in which a radial dynamic pressure is generated in the lubricant 92 as the hub 28 is rotated with respect to the shaft 26. The two radial dynamic pressure generation parts 156 and 158 are spaced apart from each other in the axial direction. The first radial dynamic pressure generation part 156 is located above the second radial dynamic pressure generation part 158. A first radial dynamic pressure generation groove 50 and a second radial dynamic pressure generation groove 52 of a herringbone shape or a spiral shape are formed in respective parts of the inner peripheral surface 28k of the shaft surrounding part 28j corresponding to the two radial dynamic pressure generation parts 156 and 158. At least one of the first radial dynamic pressure generation groove 50 and the second radial dynamic pressure generation groove 52 may be formed on the outer peripheral surface 26e of the body 26f instead of the inner peripheral surface 28k of the shaft surrounding part 28j.

The third gap 124 includes a first thrust dynamic pressure generation part 160 in which an axial dynamic pressure is generated in the lubricant 92 as the hub 28 is rotated with respect to the shaft 26. A first thrust dynamic pressure generation groove 54 of a herringbone shape or a spiral shape is formed in a part of the lower surface 28m of the shaft surrounding part 28j corresponding to the first thrust dynamic pressure generation part 160. The first thrust dynamic pressure generation groove 54 may be formed on the upper surface 110b of the housing bottom 110 instead of the lower surface 28m of the shaft surrounding part 28j.

The second gap 128 includes a second thrust dynamic pressure generation part 162 in which an axial dynamic pressure is generated in the lubricant 92 as the hub 28 is rotated with respect to the shaft 26. A second thrust dynamic pressure generation groove 56 of a herringbone shape or a spiral shape is formed in a part of the flange-facing surface 281 of the shaft surrounding part 28j corresponding to the second thrust dynamic pressure generation part 162. The second thrust dynamic pressure generation groove 56 may be formed on the under surface 26i of the flange 26g instead of the flange-facing surface 281 of the shaft surrounding part 28j.

As the rotor is rotated relative to the stator, the first radial dynamic pressure generation groove 50, the second radial dynamic pressure generation groove 52, the first thrust dynamic pressure generation groove 54, and the second thrust dynamic pressure generation groove 56 generate a dynamic pressure in the lubricant 92. The dynamic pressure supports the rotor in the radial direction and the axial direction without making contact with the stator.

The cover ring 12 is adhesively fixed to, for example, the hub 28 of the rotor so as to cover the second gas-liquid interface 120 located in the ninth gap 140. The cover ring 12 may be fixed to, for example, the flange 26g of the stator instead of the rotor. The cover ring 12 is formed in an annular shape and is made of a metal material such as stainless steel or a resin material, for example. The cover ring 12 may include a porous body such as a sintered object or include a charcoal filter so as to capture gas or mist from the lubricant 92 spread from the second gas-liquid interface 120.

The shaft surrounding part 28j is formed with a bypass communication hole 164 that bypasses the second thrust dynamic pressure generation part 162, the first radial dynamic pressure generation part 156, the second radial dynamic pressure generation part 158, and the first thrust dynamic pressure generation part 160. The bypass communication hole 164 runs straight through the shaft surrounding part 28j in the axial direction. The lubricant 92 is introduced in the bypass communication hole 164 and the lubricant 92 flows through the bypass communication hole 164 if imbalance in the dynamic pressure exits. The dynamic pressure is averaged accordingly. Consequently, the level of the first gas-liquid interface 116 and the second gas-liquid interface 120 can be maintained at a proper level even if imbalance in the generated dynamic pressure exits.

A part of the edge at the upper end of the bypass communication hole 164 is located in the first recess surface 154a and the remaining part is located in the flange-facing surface 281. The edge facing surface of the ring part 104 that faces the first recess surface 154a has a shape that conforms to the edge at the upper end of the bypass communication hole 164. The edge facing surface is formed with an edge facing recess 178 that surrounds the rotating axis R at a position corresponding to the edge at the upper end of the bypass communication hole 164. The edge facing recess 178 is formed so as to cover a part of the edge at the upper end of the bypass communication hole 164.

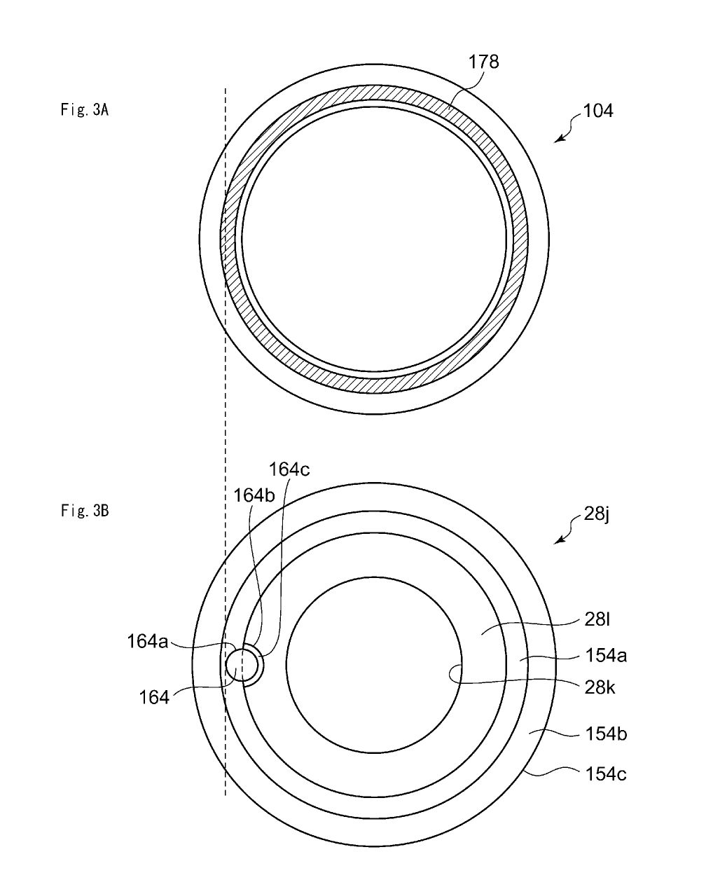

FIGS. 3A and 3B are schematic diagrams illustrating the relative positions of the edge facing recess 178 and the edge at the upper end of the bypass communication hole 164. FIG. 3A is a bottom view of the ring part 104. FIG. 3B is a top view of the shaft surrounding part 28j. In FIG. 3B, illustration of the second thrust dynamic pressure generation groove 56 is omitted for brevity.

The outermost part of a part 164a of the edge at the upper end of the bypass communication hole 164 located in the first recess surface 154a is more toward the center than the outermost part of the edge facing recess 178. The broken line in FIGS. 3A and 3B show the relative positions. A remaining part 164b of the edge at the upper end of the bypass communication hole 164 located in the flange-facing surface 281 is spot-faced so that the part 164b has a spot-faced surface 164c.

The edge facing recess 178 is formed outside the flange-facing surface 281. Therefore, the spot-faced surface 164c is located more toward the center than the edge facing recess 178. In other words, the edge facing recess 178 is located at a position removed from the remaining part 164b.

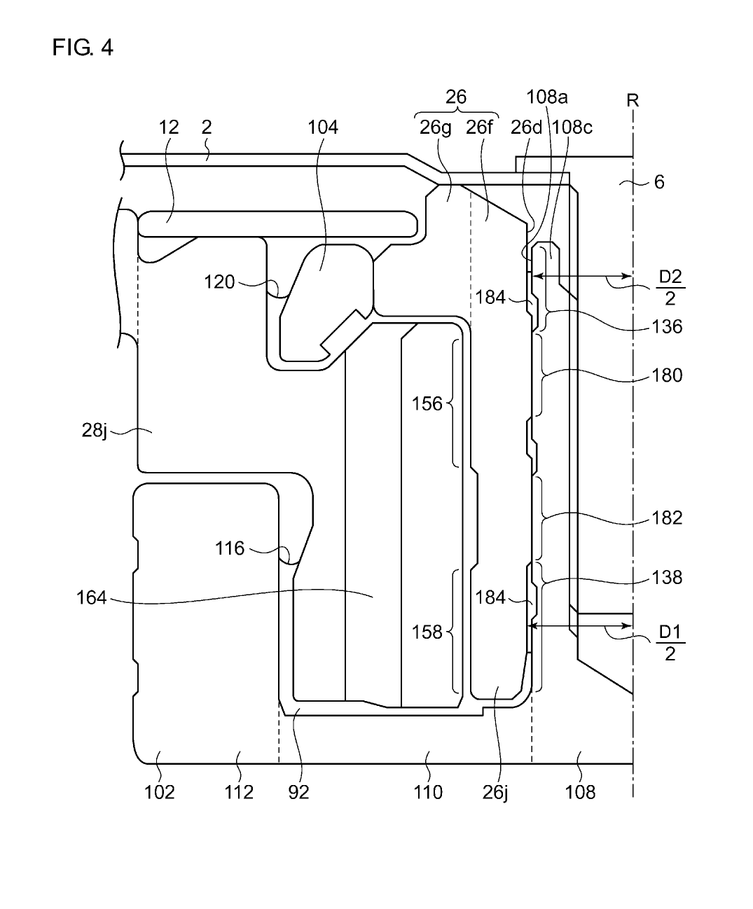

FIG. 4 is an enlarged view of a part of FIG. 2. The support projection 108 is fixed in the support hole 26d by using press-fitting and adhesion in combination. The shaft 26 surrounds an upper end 108c of the support projection 108 via a seventh gap 136. The flange 26g is positioned to surround the upper end 108c.

A lower end 26j of the shaft 26 surrounds the support projection 108 via an eighth gap 138. An adhesive agent 184 is introduced in the seventh gap 136 and the eighth gap 138. The seventh gap 136 has a wide part and a narrow part. The wide part functions as an adhesive agent reservoir for storing the adhesive agent 184. The width of the narrow part may be 20-30 μm. The eighth gap 138 is formed similarly as the seventh gap 136.

The diameter D1 at the periphery of the support hole 26d aligned with the eighth gap 138 is larger than the diameter D2 of an outer peripheral surface 108a of the support projection 108 aligned with the seventh gap 136. Therefore, the shaft 26 will be loosely fit to the support projection 108 in the initial stage of mounting the shaft 26 on the support projection 108.

The support projection 108 is press-fitted to the shaft 26 between the seventh gap 136 and the eighth gap 138. Between the seventh gap 136 and the eighth gap 138 are located two press-fitted parts 180, 182 where the outer peripheral surface 108a of the support projection 108 is press-fitted to the peripheral surface of the support hole 26d. The two press-fitted parts 180, 182 are spaced apart from each other in the axial direction. The first press-fitted part 180 is located above the second press-fitted part 182. The margin left for press-fitting in the first press-fitted part 180 and the second press-fitted part 182 may be about 5 μm. The second press-fitted part 182 is located between the first radial dynamic pressure generation part 156 and the second radial dynamic pressure generation part 158 in the axial direction. The upper end 108c is located above the upper end of the first radial dynamic pressure generation part 156.

The shaft 26 is fitted to the support projection 108 such that (1) one of the peripheral surface of the support hole 26d and the outer peripheral surface 108a of the support projection 108 is coated with an adhesive agent 184 and then the support projection 108 is inserted into the support hole 26d, or (2) both the peripheral surface of the support hole 26d and the outer peripheral surface 108a of the support projection 108 are coated with an adhesive agent 184 and then the support projection 108 is inserted into the support hole 26d. Our experiment shows that the bonding strength obtained by the method of (2) is significantly higher than the bonding strength obtained by the method of (1). By way of example, the force necessary to remove the shaft 26 from the support projection 108 is 60 kg in (2) and 50 kg in (1).

A description will be given of the operation of the rotating device 100 configured as described above. A three-phase driving current is fed to the coil 42 to rotate the magnetic recording disk 8. The flow of the driving current through the coil 42 generates a magnetic flux along the nine salient poles. The magnetic flux provides a torque to the cylindrical magnet 32, causing the rotor and the magnetic recording disk 8 fitted thereto to be rotated. By swinging the swing arm 14 by the voice coil motor 16 simultaneously, the read/write head makes a reciprocal movement on the magnetic recording disk 8. The read/write head converts magnetic data recording on the magnetic recording disk 8 into an electrical signal and delivers the data to a control board (not shown) and writes data delivered from the control board on the magnetic recording disk 8 as magnetic data.

According to the rotating device 100 of the embodiment, the shaft fixing screw 6 fixing the top cover 2 with respect to the shaft 26 is threaded into the shaft fixing screw hole 152 formed in the support projection 108. Accordingly, the support projection 108 supports the shaft 26 such that a large length of mesh is ensured between the shaft fixing screw 6 and the shaft fixing screw hole 152 without increasing the thickness of the rotating device 100. This increases the strength of bonding between the shaft fixing screw 6 and the support projection 108 and improves the capability to withstand shock and vibration.

According to the rotating device 100 of the embodiment, the support projection 108 extends to a height substantially equal to the height of the flange 26g in the axial direction. The upper end 108c of the support projection 108 is located above the first radial dynamic pressure generation part 156. Therefore, the outer peripheral surface 108a of the support projection 108 can face the peripheral surface of the support hole 26d in the radial direction over a large length. This increases the strength of bonding between the shaft 26 and the support projection 108.

The part where the outer peripheral surface 108a of the support projection 108 and the peripheral surface of the support hole 26d of the rotating device 100 according to the embodiment face each other is configured such that the two press-fitted parts 180 and 182 are sandwiched by the two gaps 136 and 138. Therefore, the shaft 26 can be mounted to the support projection 108 initially with a relative small force and press-fitting is initiated once the shaft 26 is mounted to a certain degree. This allows the shaft 26 to be bonded to the support projection 108 more easily than when the press-fitting occurs from the beginning, maintaining the right angle of the shaft 26. In other words, the initial loosely fit state functions as a guide for press-fitting and facilitates the process of press-fitting, maintaining the right angle at the same time.

Further, in the rotating device 100 of the embodiment, the shaft 26 is fixed to the support projection 108 by using press-fitting and adhesion in combination. Accordingly, the bonding strength is improved.

In the rotating device 100 according to the embodiment, the second press-fitted part 182 is located between the first radial dynamic pressure generation part 156 and the second radial dynamic pressure generation part 158 in the axial direction. Therefore, even if the shaft 26 is expanded due to the stress created in the second press-fitted part 182, the impact of the expansion on the first radial dynamic pressure generation part 156 and the second radial dynamic pressure generation part 158 is small.

Normally, the bypass communication hole 164 is formed by boring the shaft surrounding part 28j by a drill or laser from top or from bottom. Generally, the shaft surrounding part 28j is spot-faced after the boring in order to remove edge burr that may be located on the edge of the hole. This is to avoid negative impact on generation of dynamic pressure that could result as the edge burr is removed and enters the dynamic pressure generation part.

However, as regards the part 164a of the edge at the upper end of the bypass communication hole 164 located in the first recess surface 154a, it is difficult to spot-face the part 164a since the first recess surface 154a is inclined with respect to the direction of extension of the bypass communication hole 164. Even if it was able to implement, processing takes time. This is addressed in the rotating device 100 according the embodiment by forming the edge facing recess 178 in the ring part 104. Therefore, even if an edge burr remains in the part 164a of the edge of the upper end of the bypass communication hole 164 after the bypass communication hole 164 is formed, the likelihood of the edge burr being in contact with a member of the stator and removed is reduced.

Further, the remaining part 164b of the edge at the upper end of the bypass communication hole 164 of the rotating device 100 of the embodiment is spot faced.

Therefore, the likelihood of exfoliation of the edge burr is reduced. Further, the edge facing recess 178 is located at a position removed from the remaining part 164b. Therefore, unlike the case where the edge facing recess 178 is large enough to cover the remaining part 164b, the edge facing recess 178 according to the embodiment is prevented from affecting the flow of the lubricant 92 or the dynamic pressure, while maintaining the advantage of reducing the likelihood of exfoliation of the edge burr. As a result, the rotating device 100 can be designed more easily.

In the rotating device 100 according to the embodiment, the second gas-liquid interface 120 is located in the ninth gap 140. Therefore, the taper seal and the radial dynamic pressure generation part are allowed to overlap each other in the axial direction. This allows the distance between the first radial dynamic pressure generation part 156 and the second radial dynamic pressure generation part 158 in the axial direction, i.e., the bearing span, can be enlarged without being constrained so much by the length of the taper seal so that the radial rigidity of the bearing is increased.

Conversely, a sufficient length of the taper seal can be secured without being constrained so much by the bearing span so that a sufficient amount of lubricant 92 can be stored and spread of the lubricant 92 is prevented. If the amount of the lubricant 92 stored can be decreased, the ninth gap 140 and the fourth gap 132 can be narrowed accordingly. This will increase a capillary force and reduces the likelihood of the lubricant 92 leaking in the presence of a shock.

Given above is a description of the configuration and operation of rotating device according to the embodiment. The embodiment is intended to be illustrative only and it will be obvious to those skilled in the art that various modifications to constituting elements could be developed and that such modifications are also within the scope of the present invention.

A so-called outer-rotor type of rotating equipment in which the cylindrical magnet 32 is located outside the laminated core 40 is described in the embodiment. However, the present invention is not limited to this. For example, the present invention may be applied to a so-called inner-rotor type of rotating equipment in which the magnet is located inside the laminated core.

In the embodiment as described, a laminated core is assumed to be used. However, the core may not be a laminated core.

The hub 28 according to the embodiment is described as being formed of a steel material, but this is by way of example only. For example, the hub may be formed of a non-ferrous metal such as aluminum alloy or a resin material such as liquid crystal polymer in order to reduce the weight of the hub.

The bearing hole 4k according to the embodiment is described as being an axial through hole, but this is by way of example only. For example, a bottom may be provided at the lower end of the bearing hole so as to block the lower end of the bearing hole, in order to improve airtightness of the space accommodating the magnetic recording disk. To improve airtightness, the bottom of the bearing hole and the base may be formed as one piece and seamlessly.

The flange 26g according to the embodiment is described as surrounding the upper end 108c of the support projection 108, but this is by way of example only. For example, the shaft fixing screw may be threaded into the screw hole provided in the shaft and the end of the shaft fixing screw may be introduced into the central hole formed in the support projection and adhesively fixed therein.

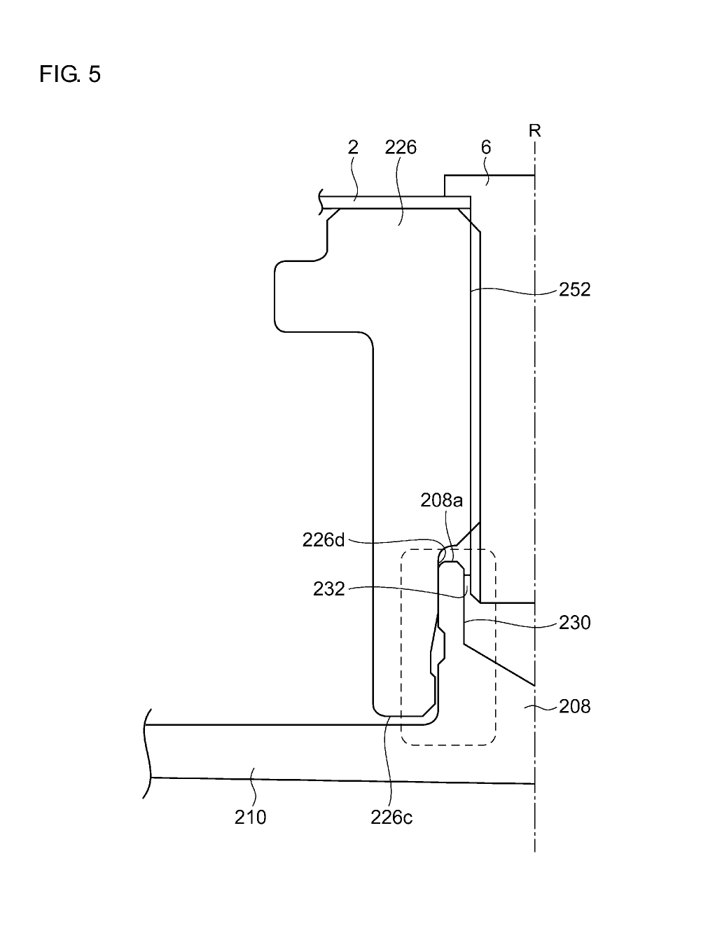

FIG. 5 shows a cross section of a shaft 226 of the rotating device according to the first variation and the neighborhood thereof. The shaft 226 is formed with a shaft fixing screw hole 252 along the rotating axis R. The shaft fixing screw hole 252 extends through the shaft 226. A support hole 226d is formed in a surface 226c toward the lower end of the shaft 226 so as to extend along the rotating axis R. The shaft fixing screw hole 252 and the support hole 226d communicate with each other. A support projection 208 is inserted into the support hole 226d and fixed therein. It should be noted that the support projection 208 is fixed in the support hole 226d by using press-fitting and adhesion in combination. A surface 208a toward the top end of the support projection 208 is formed with a non-penetrating screw support hole 230 that extends along the rotating axis R.

The shaft fixing screw 6 is threaded into the shaft fixing screw hole 252 and extends through the shaft fixing screw hole 252. The lower end of the shaft fixing screw 6 enters the screw support hole 230 and is adhesively fixed therein. In other words, an adhesive agent 232 is introduced between the shaft fixing screw 6 and the support projection 208. The screw support hole may be threaded so that the shaft fixing screw 6 is threaded into the screw support hole 230.

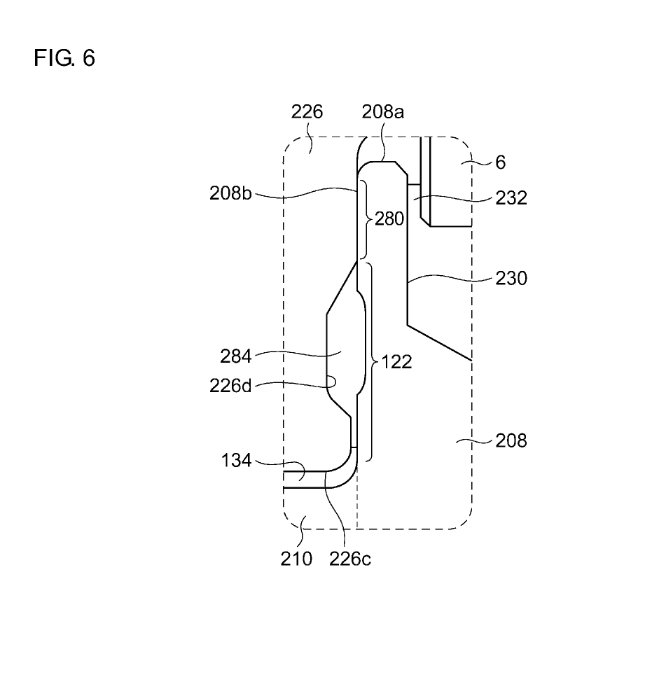

FIG. 6 is an enlarged view of a part of FIG. 5 bounded by a broken line. The shaft 226 surrounds the root of the support projection 208 via a sixth gap 122. An adhesive agent 284 is introduced in the sixth gap 122. The sixth gap 122 has a wide part and a narrow part. The wide part functions as an adhesive agent reservoir for storing the adhesive agent 284.

The support projection 208 is press-fitted to the shaft 226 above the sixth gap 122. It should be noted that a press-fitted part 280 in which an outer peripheral surface 208b of the support projection 208 is press-fitted to the peripheral surface of the support hole 226d.

The surface 226c toward the lower end of the shaft 226 faces the upper surface of a housing bottom 210 via a fifth gap 134. In mounting the shaft 226 on the support projection 208, the height of the shaft 226 can be adjusted by an amount determined by the size of the fifth gap 134. If the adhesive agent 284 is introduced into the fifth gap 134, the fifth gap 134 functions as a reservoir for the adhesive agent and prevents leakage of the adhesive agent 284.

In the rotating device according to the first variation, the shaft fixing screw 6 enters the screw support hole 230 and is fixed therein. This increases the strength of bonding between the shaft fixing screw 6 and the support projection 208. It also ensures a large length of mesh between the shaft fixing screw 6 and the shaft fixing screw hole 252. Since the shaft fixing screw 6 and the shaft 226 are directly coupled to each other, the strength of bonding between the shaft fixing screw 6 and the shaft 226 and the strength of bonding between the top cover 2 and the shaft 226 can be increased.

The shaft fixing screw hole 252 according to the variation is aligned with the shaft fixing screw 6 and the support hole 226d of the shaft 226 is aligned with the support projection 208. Therefore, the support hole 226d has a larger diameter than the shaft fixing screw hole 252. This results in a large diameter of the press-fitted part 280 in which the support projection 208 and the shaft 226 are press-fitted. This contributes to increase in the bonding strength.

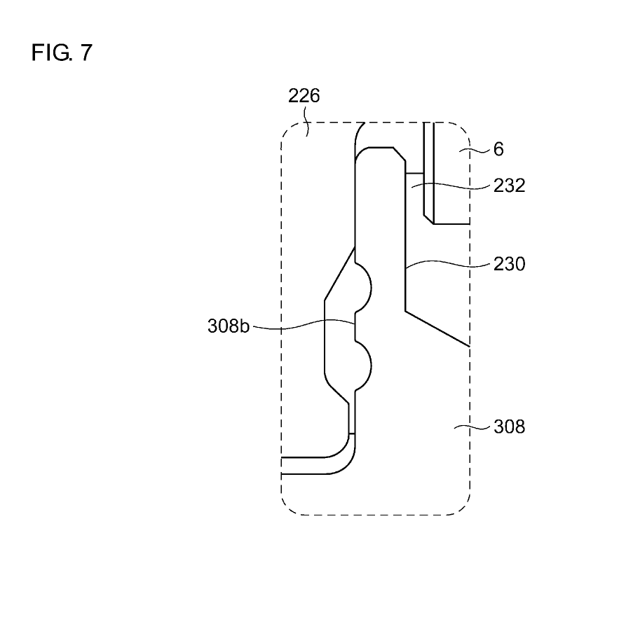

FIG. 7 shows a partial cross section of a main part of the rotating device according to the second variation. FIG. 7 corresponds to FIG. 6. The main difference between the first variation and the second variation resides in the shape of an outer peripheral surface 308b of a support projection 308.

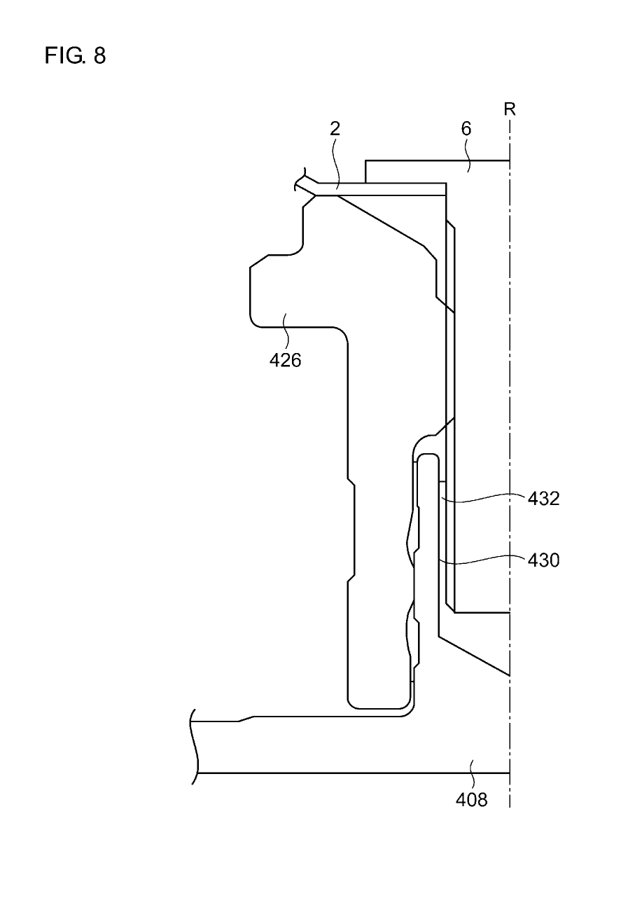

FIG. 8 shows a cross section of a shaft 426 of the rotating device according to the third variation and the neighborhood thereof. The main difference between the first variation and the third variation resides in the length of a support projection 408. The support projection 408 according to the third variation is longer than the support projection 208 according to the first variation. In this case, the strength of adhesion between the shaft fixing screw 6 and a screw support hole 430 using an adhesive agent 432 is increased. In an alternative to adhesion by the using the adhesive agent 432, the screw support hole 430 may be threaded so that the shaft fixing screw 6 is threaded into the screw support hole 430.

What is claimed is:

1. A rotating device comprising:
a rotor on which a magnetic recording disk is to be mounted; and
a stator configured to rotatably support the rotor via a fluid dynamic bearing,
wherein the stator includes:
an inner part extending along a rotating axis of the rotor;
an outer part surrounding the inner part and fixed to the inner part;
a cover configured to cover the rotor; and
a joint configured to fix the cover to the outer part,
wherein the joint enters a hole formed in the inner part along the rotating axis.

2. The rotating device according to claim 1, wherein the joint is joined to the hole.

3. The rotating device according to claim 1, wherein the stator further includes a flange extending from an end of the outer part toward the cover in a radially outward direction, and
wherein the flange surrounds an end of the inner part toward the cover.

4. The rotating device according to claim 1, wherein a dynamic pressure gap between the outer part and the rotor includes a radial dynamic pressure generation part in which a dynamic pressure in a radial direction is generated in a lubricant located in the dynamic pressure gap when the rotor is rotated with respect to the outer part, and
wherein an end of the inner part toward the cover is closer to the cover than an end of the radial dynamic pressure generation part toward the cover.

5. The rotating device according to claim 1, wherein the outer part surrounds an end of the inner part toward the cover via a first gap, and
wherein an end of the outer part opposite to the cover surrounds the inner part via a second gap.

6. The rotating device according to claim 5, wherein the inner part is press-fitted to the outer part between the first gap and the second gap.

7. The rotating device according to claim 1, wherein a dynamic pressure gap between the outer part and the rotor includes a radial dynamic pressure generation part in which a dynamic pressure in a radial direction is generated in a lubricant located in the dynamic pressure gap when the rotor is rotated with respect to the outer part,
wherein the radial dynamic pressure generation part includes a first radial dynamic pressure generation part and a second radial dynamic pressure generation part spaced apart from each other in an axial direction, and
wherein a part where the inner part is press-fitted to the outer part is located between the first radial dynamic pressure generation part and the second radial dynamic pressure generation part in the axial direction.

8. A rotating device comprising:
a rotor on which a magnetic recording disk is to be mounted; and
a stator configured to rotatably support the rotor via a fluid dynamic bearing,
wherein the stator includes:
an inner part extending along a rotating axis of the rotor;
an outer part surrounding the inner part and fixed to the inner part;
a cover configured to cover the rotor; and
a joint configured to fix the cover to the outer part,
wherein the joint enters an admission hole formed in the inner part along the rotating axis,
wherein a lubricant hole accommodating a lubricant for the fluid dynamic bearing is formed in one of the rotor and the stator, and
wherein a surface of the other of the rotor and the stator facing an edge of the lubricant hole has a shape adapted to the edge of the lubricant hole.

9. The rotating device according to claim 8, wherein the surface facing the edge of the lubricant hole is formed with a recess surrounding the rotating axis of the rotor at a position corresponding to the edge of the lubricant hole.

10. The rotating device according to claim 9, wherein at least a part of the edge of the lubricant hole is located on a plane having a normal parallel to a direction intersecting a direction in which the lubricant hole extends, and
wherein the recess is formed to cover said part of the edge of the lubricant hole.

11. The rotating device according to claim 10, wherein a remaining part of the edge of the lubricant hole is spot-faced, and
wherein the recess is formed at a position removed from the remaining part of the edge of the lubricant hole.

12. The rotating device according to claim 8, wherein the stator further includes a flange extending from an end of the outer part toward the cover in a radially outward direction, and
wherein the flange surrounds an end of the inner part toward the cover.

13. The rotating device according to claim 8, wherein a dynamic pressure gap between the outer part and the rotor includes a radial dynamic pressure generation part in which a dynamic pressure in a radial direction is generated in a lubricant located in the dynamic pressure gap when the rotor is rotated with respect to the outer part, and
wherein an end of the inner part toward the cover is closer to the cover than an end of the radial dynamic pressure generation part toward the cover.

14. The rotating device according to claim 8, wherein the outer part surrounds an end of the inner part toward the cover via a first gap, and
wherein an end of the outer part opposite to the cover surrounds the inner part via a second gap.

15. A rotating device comprising:
a rotor on which a magnetic recording disk is to be mounted; and
a stator configured to rotatably support the rotor via a fluid dynamic bearing,
wherein a lubricant hole accommodating a lubricant for the fluid dynamic bearing is formed in one of the rotor and the stator, and
wherein a surface of the other of the rotor and the stator facing an edge of the lubricant hole has a shape adapted to the edge of the lubricant hole.

16. The rotating device according to claim 15, wherein the surface facing the edge of the lubricant hole is formed with a recess surrounding a rotating axis of the rotor at a position corresponding to the edge of the lubricant hole.

17. The rotating device according to claim 16, wherein at least a part of the edge of the lubricant hole is located on a plane having a normal parallel to a direction intersecting a direction in which the lubricant hole extends, and
wherein the recess is formed to cover said part of the edge of the lubricant hole.

18. The rotating device according to claim 17, wherein a remaining part of the edge of the lubricant hole is spot-faced, and
wherein the recess is formed at a position removed from the remaining part of the edge of the lubricant hole.

19. The rotating device according to claim 17, wherein the stator includes:
an extension extending along the rotating axis of the rotor; and
a projection projecting from an end of extension in a radial direction,
wherein the rotor includes a surrounding part surrounding the extension and facing the projection in an axial direction,
wherein a gap between the surrounding part and the extension includes a radial dynamic pressure generation part in which a dynamic pressure in a radial direction is generated in a lubricant located in the gap when the surrounding part is rotated with respect to the extension,
wherein a surface of the surrounding part facing the projection is formed with an admission recess in which a part of the projection enters,
wherein a lubricant hole is formed in the surrounding part, and
wherein a surface having a normal parallel to a direction intersecting a direction in which the lubricant hole extends is a surface of the surrounding part facing the part of the projection that enters the admission recess.

20. The rotating device according to claim 19, wherein the part of the projection that enters the admission recess is separate from the extension.
